(19) United States
(12) Patent Application Publication
(10) Pub. No.: US 2006/0266125 A1
(43) Pub. Date: Nov. 30, 2006

(54) Method of predicting damage of dies

(75) Inventors: Hiroaki Yoshida, Nagoya (JP); Shigekazu Itoh, Nagoya (JP); Takuma Okajima, Nagoya (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: DAIDO STEEL CO., LTD., Nagoya (JP)

(21) Appl. No.: 11/440,045

(22) Filed: May 25, 2006

(30) Foreign Application Priority Data
May 25, 2005 (JP) 2005-153198

(51) Int. Cl. G01B 5/30

(52) U.S. Cl. 73/760

(57) ABSTRACT

Disclosed is a method of predicting damage of dies for plastic processing of metals, typically, forging dies, to contribute to die design including choice of material, hardness and configuration of the die. The method is characterized in that the plastic flow criteria value “Dc” defined by the formula below is calculated: Dc=σ_{eq}/(YS×S_{Rtotal}), wherein σ_{eq} is Von Misese's equivalent stress, YS is dynamic compressive yield stress, and S_{Rtotal} is softening rate, and that the damage of die is predicted with the condition that, if the value of Dc reaches 1.0, the plastic deformation or the plastic flow begins to occur

### BACKGROUND OF THE INVENTION

1. Technical Field

The present invention concerns a method of predicting damage of dies. More specifically, the invention concerns a method of predicting damage of dies for plastic processing of metals, typically, forging dies, by predicting damage caused by plastic flow, and utilizing the results of prediction for die design including choice of materials, hardness thereof and determining the die configuration so as to establish countermeasures for prolongation of the die lives. The plastic flow is a phenomenon of progress of plastic deformation at the surface of the dies.

2. Prior Art

At manufacturing and application of a forging die various methods of predicting damages in the dies have been developed and utilized for manufacture of dies of longer life. As the method of prediction it is generally employed to calculate temperature and stress distribution in a die by finite element analysis and then substitute the calculated values for constitutive equations to presume low cycle fatigue life and abrasion. For example, Japanese Patent Disclosure No. 2002-321032 discloses a technique of predicting die life on the basis of die abrasion according to an abrasion model adopting conditions inherent in forging dies.

One of the main factors causing damage and shortening life of a forging die during using is plastic flow or softening flow of the die. Conventional technologies for predicting damage of die are related only to low cycle fatigue life at a room temperature, heat check during warm processing and abrasion during hot forging, and the problem of plastic flow has not been confronted with. In forging vigorous temperature change caused by sudden heating or cooling is a more important factor causing damage, and therefore, there has been demand for a model dealing with the phenomenon of gradual softening of die materials.

### SUMMARY OF THE INVENTION

The object of the present invention is to provide a method of predicting damage of dies by predicting progress of plastic flow causing damage of dies, so as to utilize the results and to enable design of improved dies

The method according to the invention achieving the above-mentioned object is a method of predicting damage caused by plastic flow, which influences the life of a die for plastic processing of metals to contribute to die design including choice of materials, hardness thereof and determining configuration of the die. The method of predicting damage of dies according to the invention is characterized in that the plastic flow criteria value “Dc” defined by the formula below is calculated on each material for die:
Dc=σ_{eq}/(YS×S_{Rtotal})
wherein, σ_{eq} is Von Misese's equivalent stress, YS is dynamic compressive yield stress, and S_{Rtotal} is softening rate. The S_{Rtotal} is given by the formula:
S_{Rtotal}=S_{Rtemp}×α
wherein, S_{Rtemp} is given by the formula:
S_{Rtemp}=1−exp{−C₁(t/t_{0.2})ⁿ}

provided that t(sec)=C₂×exp(Q/RT)

wherein, C₁ and C₂ are constants, Q is activation energy, R=8.31, and
α=D×σ_{eq}/YSᵢₙᵢₜ
wherein, YSᵢₙᵢₜ is initial dynamic yield strength, and D is 1.9.
and that the damage of die is predicted with the condition that, if the value of Dc reaches 1.0, the plastic deformation or the plastic flow begins to occur

### BRIEF EXPLANATIO OF THE DRAWINGS

FIG. 1 is a graph illustrating dynamic compressive yield strength of heat-treated state and softened state of SKD61 steel, a typical hot processing tool material, along increase of the temperature;

FIG. 2 is a graph prepared by measuring change of hardness of SKD61 along the lapse of time, under the condition that the steel is being kept heating and posing with load;

FIG. 3 is explanatory drawing of the device for obtaining the data in FIG. 2;

FIG. 4 is a graph similar to FIG. 2 concerning MH85 steel, which is a matrix type high speed steel provided by Daido Tokushuko Co., Ltd., prepared by plotting the change of softening rate along the lapse of heating time corresponding to the increment model;

FIG. 5 is a conceptual drawing explaining the steps of forging test carried out in the working example of the invention and the shape of the punch used;

FIG. 6 is a computer graphics (hereinafter referred to as “CG”) showing the softening rate obtained by computer simulation on the data of a working example of the invention;

FIG. 7 is a CG showing the plastic flow criteria value Dc also obtained from the data of a working example of the invention without taking the softening behavior into account based on a conventional technology;

FIG. 8 is a CG showing the plastic flow criteria value Dc also obtained from the data of a working example of the invention with taking the softening behavior into account according to the present invention;

FIG. 9 is a CG showing the distribution of yield strength also obtained from the data of a working example of the invention without taking the softening behavior into account based on a conventional technology;

FIG. 10 is a CG showing the distribution of yield strength also obtained from the data of a working example of the invention with taking the softening behavior into account according to the present invention;

FIG. 11 is a graph showing the change in abrasion of the forging punch used in the forging tests of the present invention at increase of shot numbers; and

FIG. 12 is a graph showing the hardness distribution in the forging punch after being used in the forging tests of the present invention.

### DETAILED EXPLANATION OF THE PREFERRED EMBODIMENTS

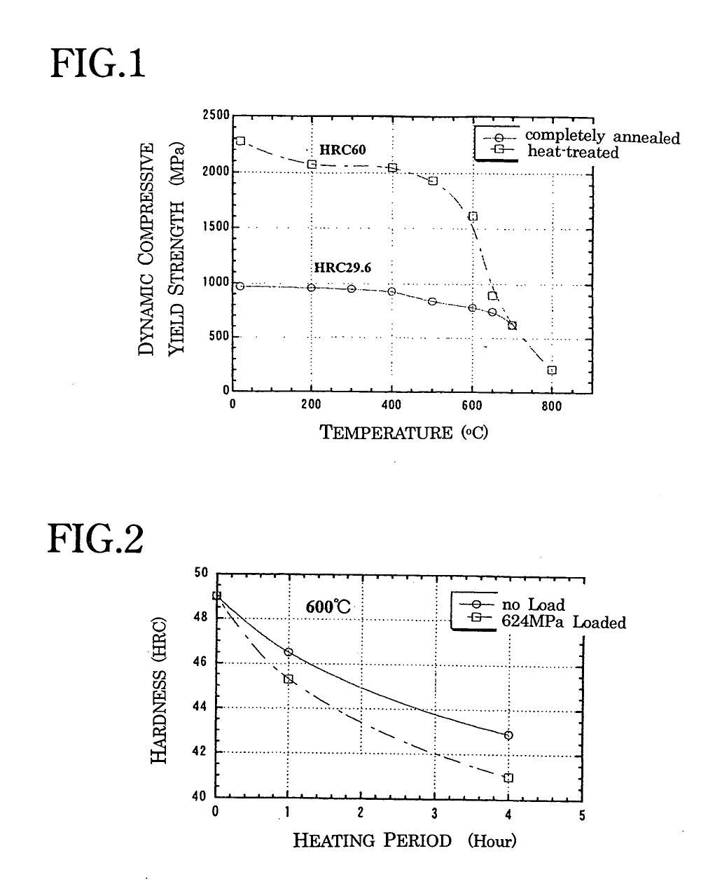

A hot processing tool steel, SKD61 (standardized by JIS), was used as the material. Some pieces of the sample steel were heat treated to hardness HRC49 and the others were completely annealed to soft. Both the sample pieces were subjected to compression tests to measure the compressive yield strength YS in the temperature range from the room temperature to 700° C. or 800° C. to obtain the data shown in FIG. 1. With the indication of the compressive yield strength (MPa) of the heat-treated sample (softening rate 0%) as YSᵢₙₜᵢ, and those of the softened samples (softening rate 100%), YS_{low}, the relation between YS and the temperature T was found to be as follows:
YSᵢₙₜᵢ=−3×10⁻⁶T³+0.0031T²−1.9458T+1929.7 (T<600° C.)
YSᵢₙₜᵢ=9926×exp(−0.0077T) (T≧600° C.)
YS_{low}=−0.0008T²+0.06312T+747.25.2

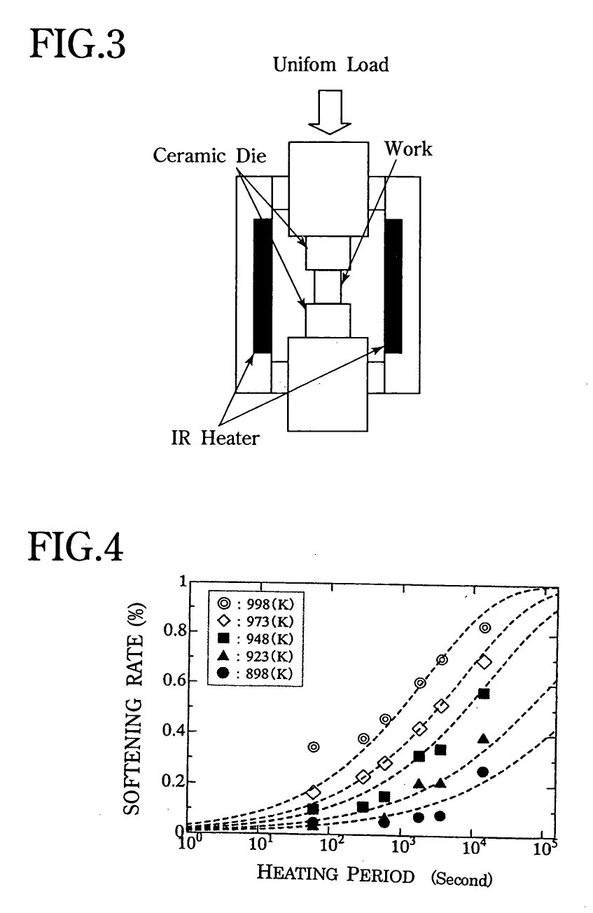

In order to determine the softening behavior of SKD61 steel of hardness HRC49 a test piece was kept at 600° C. for 1 to 4 hours under the load of 624 MPa (compressive stress) and the hardness was measured at every 1 hour to compare with the case of no load. The data is shown in FIG. 2. The apparatus for posing load at high temperature has the structure illustrated in FIG. 3. Rate of softening, S_{R}, can be shown as follows:
S_{R}⁴=S_{R0}⁴+C×t×exp(−Q/RT)
wherein, Q is activation energy, and RT, gas constant.

High temperature yield strength YS (MPa), to which softening is taken into account, will be as follows:
YS=(1−100×SR)×(YSᵢₙᵢₜᵢ−YS_{low})+YS_{low}
wherein, YS is a dynamic compression yield strength depending on the temperature.

The compression yield strength YS of the MH85 steel, the hardness of which was adjusted to HRC58.7, was determined in the temperature range from the room temperature to 800° C. or 700° C. The following relations between the compressive yield strength and the temperature T were obtained from the data thus obtained:
YSᵢₙₜᵢ=−5×10⁻⁶T³+0.0047T²−1.5574T+2510.7 (T<600° C.)
YSᵢₙₜᵢ=9411202×exp(−0.0105T) (T≧600° C.)
YS_{low}=−0.0006T²+0.0542T+1049.2

In order to determine the softening behavior of the MH85 steel, by the same procedures as done in regard to SKD61, a test piece was kept at 600° C. for 1 to 4 hours under the load of 624 MPa and the hardness was measured at every 1 hour. The softening rate was calculated with the data thereof. To deal with the increment model the softening rates are plotted at the increase of the soaking time. The graph obtained is shown in FIG. 4.

Prediction of the damage of dies in accordance with the present invention enables predicting the damage caused by plastic flow, which has been, though an important factor, not confronted with by the conventional methods for prediction, more accurately, and hence, it will be possible to establish more effective countermeasures. Those skilled in the art may, with reference to the working examples described below, by constructing databases on each material steels, predict the damage of die, and on the results, carry out design of the optimum die.

If the die enjoys a longer life, the contribution will be not only to decrease in die-manufacturing costs but also to decrease in manufacturing costs of processed parts such as forged parts through reduction in time and labor for exchanging the dies.

The method of predicting damages of dies according to the invention may exhibit the performance to the dies for forging. The method will be, however, applicable to other dies such as those for die-casting, which are used under similar conditions of high temperature and high stress. Through the prediction of damages of dies desired properties of die materials will be learned as a matter of course and the indication for developing the die materials can be obtained. Thus, the invention may contribute also to development of alloy technologies.

### EXAMPLES

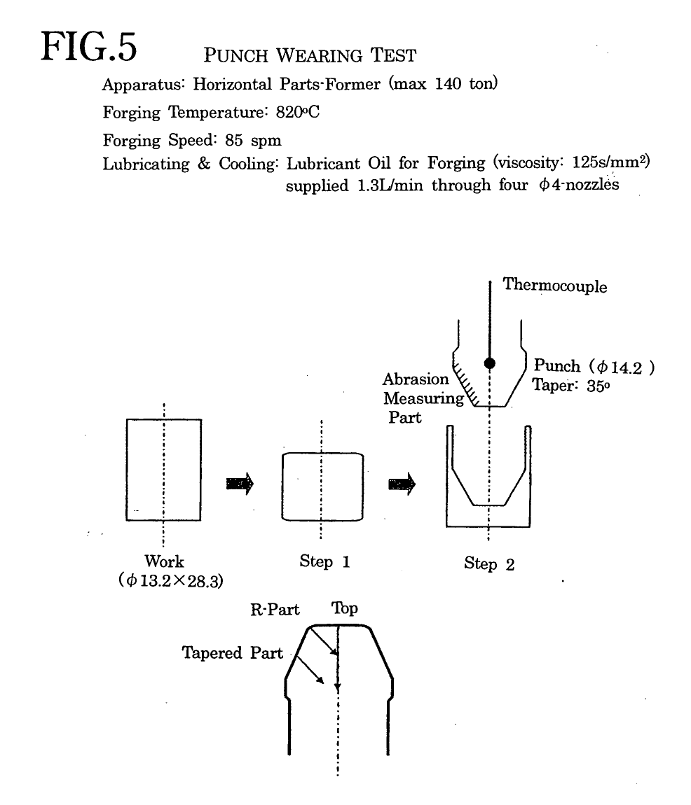

The following example of predicting damage according to the invention was carried out using a practical forging apparatus. MH85 steel was used as the material and a punch of the shape shown in FIG. 5 was manufactured. The punch was installed on a horizontal type parts-former and used for forging to determine the wearing thereof. The forging consists of two steps, as shown in FIG. 5, swaging in the first step and backward extrusion in the second step. Observation of damage of the die after the second step will teach the type and the extent of the damage.

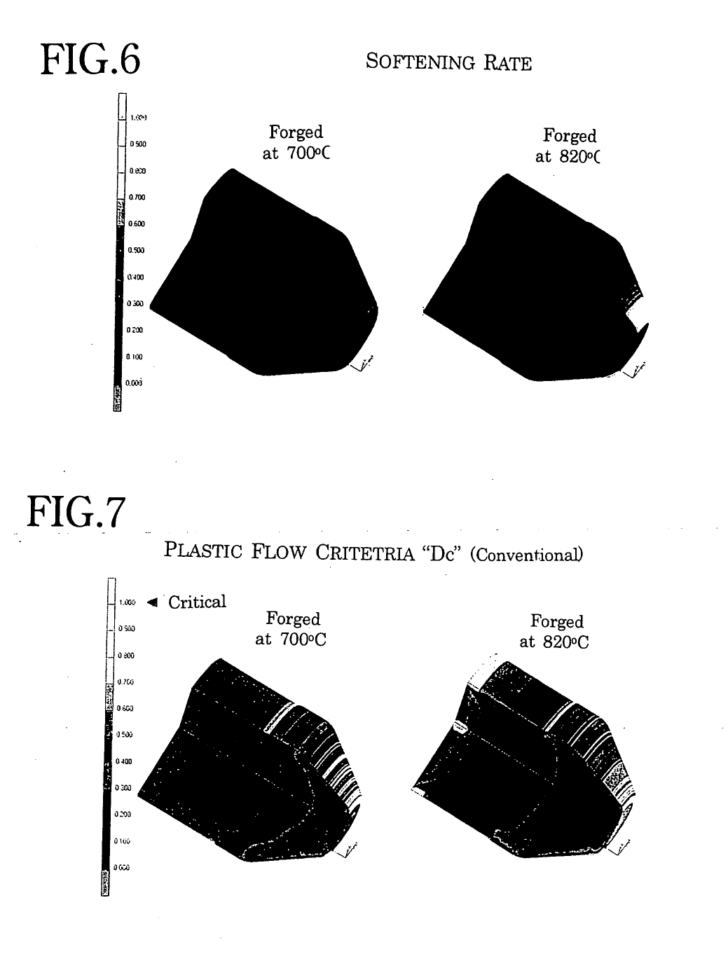

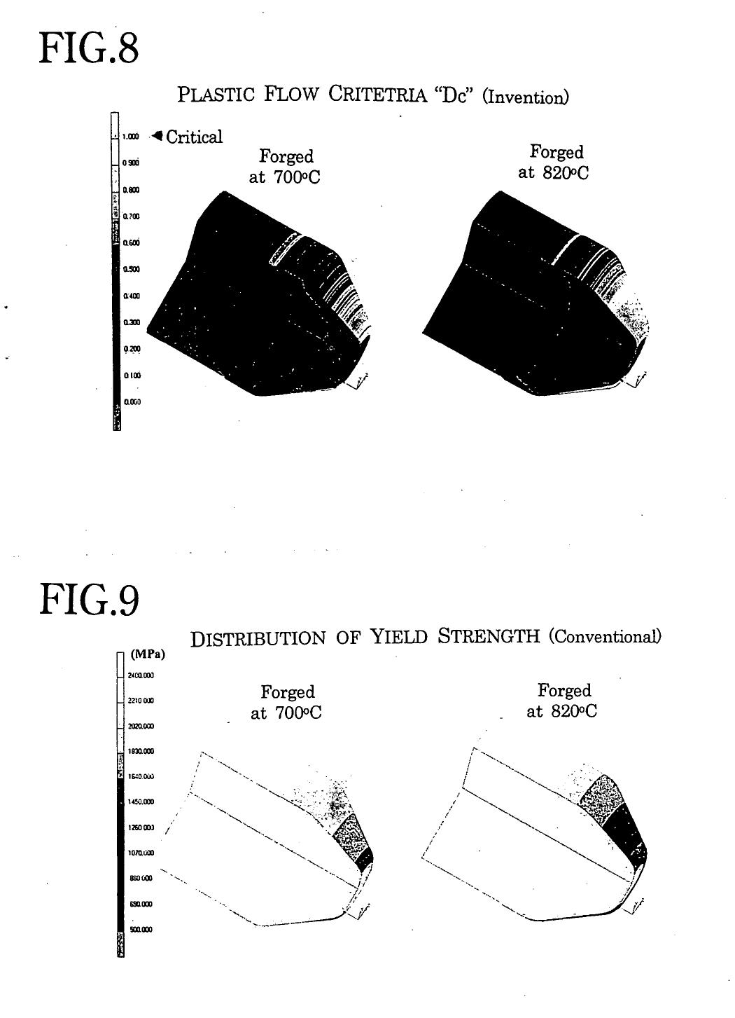

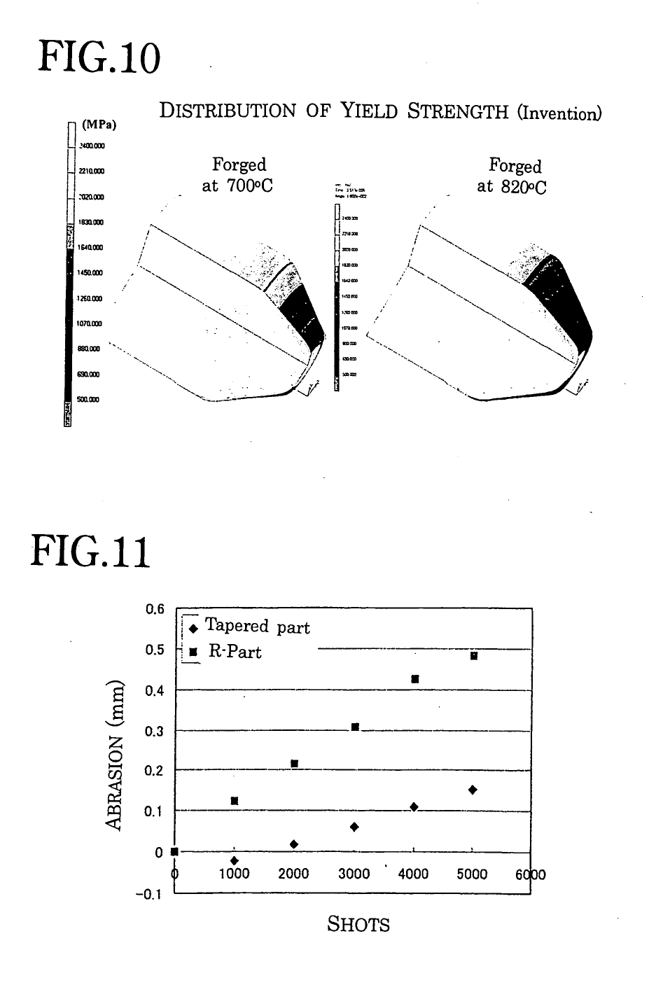

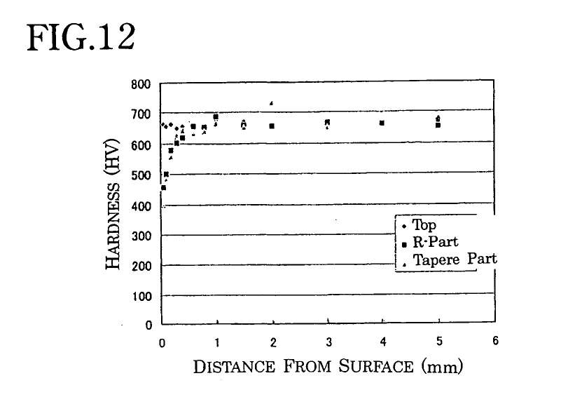

The CGs of the figure number given in the parentheses were obtained using the above data by computer simulation for predicting damage on the cases of forging temperature 700° C. and 820° C.
[FIG. 6] Softening Rate
[FIG. 7] Plastic Flow Criteria Value “Dc” (according to the conventional technology where the softening behavior is not considered)
[FIG. 8] Plastic Flow Criteria Value “Dc” (according to the present invention where the softening behavior is considered)
[FIG. 9] Distribution of the Yield Strength (according to the conventional technology where the softening behavior is not considered)
[FIG. 10] Distribution of the Yield Strength (according to the present invention where the softening behavior is not considered)

Forging was continued for 5000 shots, during which abrasion at the “tapered part” and the “R part” of the punch was determined at every 1000 shots, and after 5000 shots distribution of the hardness at the tapered part, the R part and the “top part” of the punch was determined. The results are as shown in FIG. 10 (increase in the wearing extent) and FIG. 11 (hardness distribution). As the conclusion it was found that, by comparison of the CGs shown in FIGS. 7-10 and the practical wear of the punch, prediction of the damage can be performed more accurately when the softening behavior of the forging die material is taken into account in accordance with the present invention.

We claim:

1. A method of predicting damage of dies used for plastic processing of metallic materials by predicting damage caused by plastic flow so as to contribute to die design including choice of materials, hardness thereof and determining configuration of the die, characterized in that the plastic flow criteria value “Dc” defined by the formula below is calculated:
Dc=σ_{eq}/(YS×SRₜₒₜₐₗ)
wherein, σ_{eq} is Von Misese's equivalent stress, YS is dynamic compressive yield stress, and S_{Rtotal} is softening rate; S_{Rtotal} is given by the formula:
S_{Rtotal}=S_{Rtemp}×?
wherein, S_{Rtemp} is given by the formula:
S_{Rtemp}=1−exp{−C₁(t/t_{0.2})ⁿ}
provided that t(sec)=C₂×exp(Q/RT)
wherein, C₁ and C₂ are constants, Q is activation energy, R=8.31, and
?=D×σ_{eq}/YSᵢₙᵢₜ
wherin, YSᵢₙᵢₜ is initial dynamic yield strength, and D being 1.9.
and that the damage of die is predicted with the condition that, if the value of Dc reaches 1.0, the plastic deformation or the plastic flow begins to occur

2. The method of predicting damage of dies according to claim 1, wherein the material of the die is SKD61, a hot processing die steel, or MH85, a matrix high speed tool steel.
